(19) United States
(12) Patent Application Publication
(10) Pub. No.: US 2015/0151505 A1
(43) Pub. Date: Jun. 4, 2015

(54) PAPERBOARD MANUFACTURE

(71) Applicant: CORCEL IP LIMITED, Hamilton (NZ)

(72) Inventors: Patrick Petrus Antonius Maria Van Berlo, Hamilton (NZ); Jason Paul Rogers, Hamilton (NZ)

(21) Appl. No.: 14/406,932

(22) PCT Filed: May 9, 2013
(86) PCT No.: PCT/NZ2013/000081

§ 371 Date: Dec. 10, 2014

(30) Foreign Application Priority Data
Jun. 15, 2012 (NZ) 600669
Dec. 18, 2012 (NZ) 604797
Mar. 4, 2013 (NZ) 607809
Mar. 6, 2013 (NZ) 607894

(51) Int. Cl. B32B 3/28; B32B 37/12; D21H 27/32; B32B 37/18; B32B 7/04; B32B 29/08; B32B 38/00; B32B 37/00

(52) U.S. Cl. CPC B32B 3/28; B32B 38/0012; B32B 38/0008; B32B 38/0004; B32B 37/1292; B32B 37/0046; B32B 37/0076; B32B 37/18; B32B 7/045; B32B 29/08; D21H 1/04

(57) ABSTRACT

A machine for producing corrugated paperboard is provided, including: an endless fluted conveyor belt assembly having an endless fluted conveyor belt including a plurality of adjacent flutes, wherein the flutes are configured to correspond to the teeth on a corrugating roller which is located at the upstream end of the endless fluted conveyor assembly; at least one source of electromagnetic radiation and associated support surface located downstream of a glue applicator, the associated support surface also being sufficiently proximate to the flutes on the endless fluted conveyor belt, so as in use, to be capable of at least partially holding newly glued planar sheet and corrugated sheet material together; and wherein the machine further includes an industrial inkjet printer which is positioned to print a planar liner sheet prior to the liner sheet being bonded to a corrugated sheet material.

### TECHNICAL FIELD

The present invention relates to improvements in and relating to paperboard manufacture.

### BACKGROUND ART

In the manufacture of conventional corrugated paperboard the corrugated sheet material is formed by running the paper to be corrugated in between two corrugating rollers.

This is illustrated in the exemplary example depicted in FIG. 1 which is taken from U.S. Pat. No. 4,447,285. In FIG. 1 it can be seen the paper after being meshed between the two intermeshing rollers travels at least partially around one of the rollers to enable the newly formed paper flutes to remain in contact with the corrugations of the roller following formation. This retention of the newly fluted paper against the corrugations of the corrugating roller—post intermeshing of the paper between the opposed corrugating rollers—helps to reduce degradation of the newly imparted flute profile to the paper: prior to lamination to a planar liner sheet. In addition, this retention enables a glue roller to contact the flute tips without deforming the flutes as they are resting on the corrugated teeth of the corrugating roller; and this also enables a pressure roller to contact and apply pressure to the flute tips, as the liner sheet is brought into contact, to form single face corrugated paperboard.

However, a drawback of conventional corrugators as shown in FIG. 1 is that they turn the freshly corrugated medium through at least 90° C. or more, as it travels around one of the corrugator rollers. The reason why this turning is a drawback, is that it places the paper under undue tension which in turn causes some flattening of the corrugations.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DEFINITIONS

The term ‘associated support surface’ as used herein refers to a substantially planar surface from or through which electromagnetic magnetic radiation is, or can be, emitted, whether directly or indirectly.

The term ‘industrial inkjet printer’ as used herein refers to a single pass high speed ink jet printer which has a printer head which has an array of nozzles which span the width of the material to be printed and preferably includes a heat source.

### SUMMARY OF INVENTION

According to a first aspect there is provided a machine for producing corrugated paperboard which includes:
an endless fluted conveyor belt assembly having an endless fluted conveyor belt including a plurality of adjacent flutes thereon wherein the flutes are configured to correspond to the teeth on a corrugating roller which is located at the upstream end of the endless fluted conveyor assembly;
at least one source of electromagnetic radiation and associated support surface located downstream of a glue applicator, the associated support surface also positioned substantially parallel to, the plane of the endless fluted conveyor belt said associated support surface also being sufficiently proximate to the flutes on the endless fluted conveyor belt, so as in use, to be capable of at least partially holding newly glued planar sheet and corrugated sheet material together.

According to a second aspect of the present invention there is provided a machine for producing corrugated paperboard substantially as described above wherein the associated support surface covers a source of electromagnetic radiation.

According to a third aspect of the present invention there is provided a machine for producing corrugated paperboard substantially as described above wherein the associated support surface is also the source of electromagnetic radiation itself.

According to a fourth aspect of the present invention there is provided a machine for producing corrugated paperboard substantially as described above wherein the source of electromagnetic radiation and associated support surface are located adjacently downstream of a redirect bar which brings the planar sheet into contact with droplets of glue on the crests of the corrugated sheet material.

According to a fifth aspect of the present invention there is provided a machine for producing corrugated paperboard substantially as described above wherein the associated support surface is located adjacently downstream of a redirect bar which brings the planar sheet into contact with droplets of glue on the crests of the corrugated sheet material.

According to a sixth aspect of the present invention there is provided a machine for producing corrugated paperboard substantially as described above wherein the machine includes an endless tensioned belt assembly which holds planar sheet material and the corrugated sheet material together so a bond is formed there between which is located adjacently downstream of the source of electromagnetic radiation and associated support surface.

According to a seventh aspect of the present invention there is provided a machine for producing corrugated paperboard substantially as described above wherein the machine includes a laminator module comprising:
upper and lower opposed contact surfaces at least one being in the form of a tensioned conveyor belt, the upper and lower opposed contact surfaces, in use, being configured to receive and press there between:
a) planar sheet material; and
b) single face corrugated sheet material from the corrugator module; and
a glue applicator for applying adhesive to the single face corrugated board and/or planar sheet material prior to travelling between the upper and lower contact surfaces which hold the planar sheet material and single face corrugated board together so a bond is formed there between; and
wherein either the upper or the lower opposed contact surface includes as part thereof, or is formed from, at least one source of electromagnetic radiation and associated support said associated support surface being positioned so as to at least partially hold newly glued double face sheet material together.

According to the eighth aspect there is provided a corrugated sheet material substantially as described above. According to a ninth aspect there is provided a machine for producing corrugated paperboard substantially as described above wherein the machine includes an inkjet printer which is positioned to print a planar liner sheet prior to the liner sheet being bonded to a corrugated sheet material.

According to a tenth aspect there is provided a machine for producing corrugated paperboard substantially as described above wherein the machine includes a galvo-head laser unit positioned to cut paperboard exiting the machine.

According to a eleventh aspect there is provided a machine for producing corrugated paperboard via a process not requiring steam which includes an industrial inkjet printer which is positioned to print a liner sheet prior to the liner sheet being bonded to a corrugated medium.

According to a twelfth aspect there is provided a machine for producing corrugated paperboard via a process not requiring steam which includes a galvo-head laser unit positioned to cut paperboard exiting the machine.

According to a thirteenth aspect there is provided a method of increasing the speed of a machine for producing corrugated paperboard via a process not requiring steam via use:
an upstream industrial ink jet printer;
   to warm the liner sheet prior to bonding to a corrugated medium.

### BRIEF DESCRIPTION OF THE DRAWINGS

Further aspects of the present invention will become apparent from the ensuing description which is given by way of example only and with reference to the accompanying drawings in which:

FIG. 1 shows exemplary prior art corrugator taken from FIG. 2 of U.S. Pat. No. 4,447,285.

FIG. 2 shows a schematic perspective view of a single face linear corrugator in accordance with one aspect of the present invention;

FIG. 3 shows a side view of a double face linear corrugator in accordance with another aspect of the present invention;

FIG. 4 shows a schematic side view of a double face linear corrugators in accordance with another aspect of the present invention.

### BEST MODES AND ILLUSTRATIVE EXAMPLES

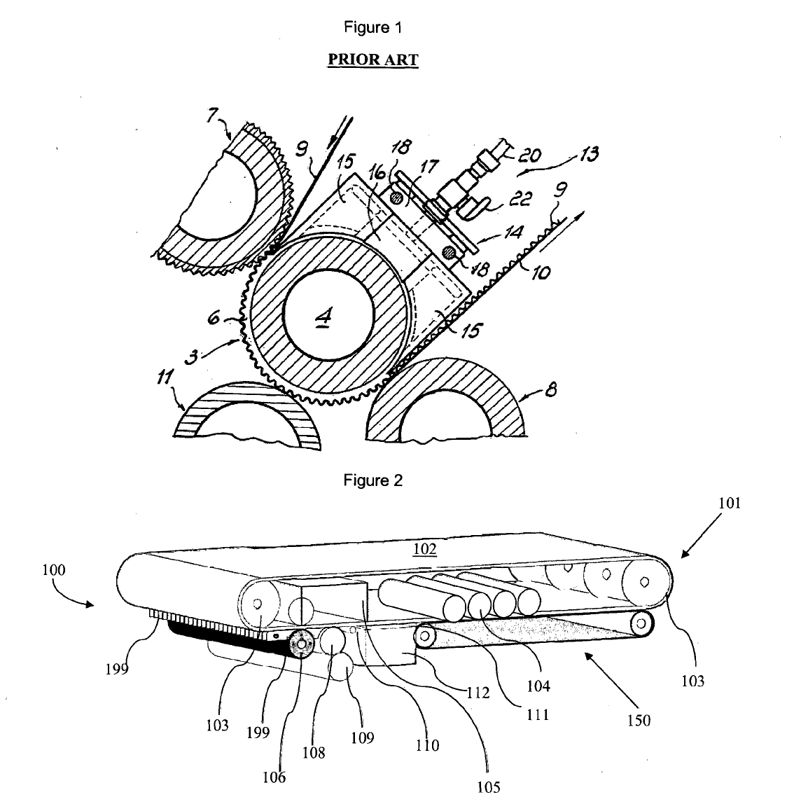

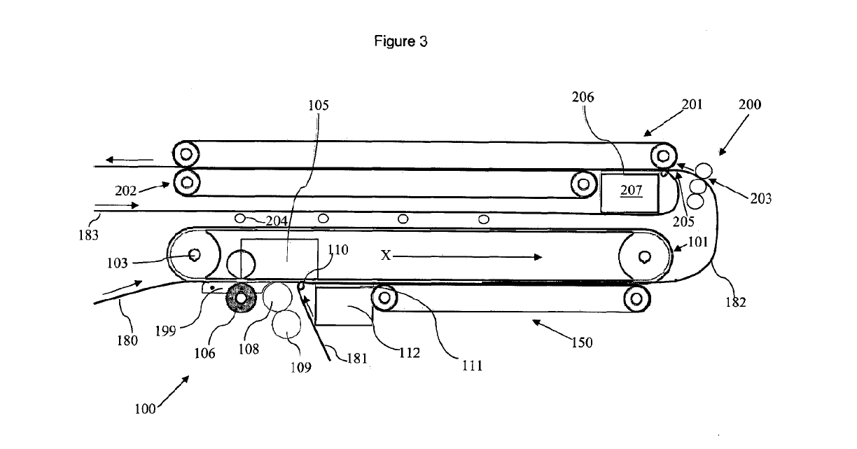

FIG. 2 shows an apparatus for manufacturing single face corrugated sheet material in the form of a single face linear corrugator generally indicated by arrow (100). FIG. 3 shows the single face corrugator (100) of FIG. 2 fitted with a double facer laminating station. For ease of reference the paper sheets used in the corrugator (100) are shown in FIG. 3 and not FIG. 1.

In FIG. 2 the single face linear corrugator (100) has an endless slatted conveyor belt assembly (101) having an endless fluted conveyor belt (102)—(formed from a plurality of adjacent fluted slats (not shown))—which is driven by a drive mechanism having a motor (not shown) and drive sprockets (103). The endless conveyor belt assembly (101) has a number of dummy rollers (104) which keep the conveyor belt (102) pressed onto:

an associated support surface in the form of a sheet quartz glass (111) which covers a source of electromagnetic radiation in the form of a bank of medium wave infrared heaters (112) which span: across the width of the corrugator, and along the length of the glass 111 in the direction in which the newly glued single face paperboard travels; and
an endless tensioned belt assembly (150).

The drive mechanism and rollers of the endless tensioned belt assembly (150) are not shown given such arrangements are well known in the art.

The linear single face corrugator (100) has a corrugating roller (106) which is formed by a number of spaced apart adjacent corrugating discs which are located a spindle (198). In between each of the corrugating discs are support fingers (199) which hold the Kraft paper to be corrugated (180) against the fluted slats on the endless fluted conveyor belt (102) as the paper (180) enters the corrugator (100).

The endless slatted conveyor belt assembly (101) has a vacuum pump (105) which can apply a vacuum to freshly corrugated sheet material in the form of Kraft paper (not shown) which has just passed in between corrugating roller (106) and endless slatted conveyor belt (102). Gaps between the adjacent slats allow the vacuum to be imparted onto the corrugated Kraft paper—this feature is known in the art and is shown in FIG. 11 of the applicant's earlier patent application WO 2011/122968.

After exiting the corrugating roller (106) the corrugated Kraft paper has a controlled amount of adhesive (not shown) applied to the apex contact portions (not shown) of the crests (not shown) via a glue roller (108) which has a helically grooved surface (not depicted). In use, adhesive is taken from a glue tray (not shown) and transferred to the glue roller (108) via a glue pick-up roller (109).

A planar sheet of material in the form of Kraft paper (herein the “first liner sheet”) (181) passes around a redirect bar (110) and is feed between the endless fluted conveyor surface (102) and the associated support surface (111). The redirect bar (110) as well as a set of dummy rollers (104) in conjunction with surface (102) apply pressure to the corrugated paper and liner sheet to hold them together until the bond is at least partially formed.

Additionally, the heat from the medium wave IR heater (112) helps set the glue which will hold the corrugated paper to the liner sheet to form single face paperboard (182). To further ensure a bond has formed between the corrugated paper and the liner sheet the newly formed single face paperboard (182) then travels along endless tensioned belt assembly (150). The length of the source of electromagnetic radiation and associated support surface (111) relative to the direction in which the newly formed corrugated paperboard travels, depends on the speed at which the newly formed corrugated paperboard is travelling, and bond time of the adhesive used.

FIG. 3 shows a double facer apparatus as indicated by arrow (200). The apparatus (200) situated below a single face corrugating module in the form of a linear corrugator (100) substantially as described above in relation to FIG. 2.

As can be seen Kraft paper (180) to be corrugated enters the linear corrugator (100) upstream of corrugating roller (106) and Kraft paper (181) which will form the first liner sheet enters the linear corrugator (100) after the glue rollers (108, 109) as shown.

The double facer (200) has opposed upper and lower contact surfaces which are in the form of endless opposed tensioned belt assemblies (201,202) and a glue applicator and nip roller assembly (203) through which the single face corrugated board (182) passes before entering the double facer (200). The glue roller assembly (203) is substantially the same as that described in relation to FIG. 2. The Kraft paper (183) which forms the double face liner sheet enters the apparatus (200) and travels above the top of the endless slatted conveyor (101) of the linear corrugator (100) on support bars (204) before it enters the double facer (200) together with the single face corrugated board at the point indicated by arrow (205).

The double facer (200) also has as part of the lower contact surface an associated support surface (206) positioned above an source of electromagnetic radiation in the form of a bank of medium wave infrared heaters (207) positioned adjacent and downstream of the redirect bar (208) which directs the liner sheet (183) into the double facer (200).

It will be appreciated by those skilled in the art that the planar sheet material used in the embodiments shown in FIGS. 2 and 3 can in some embodiments be pre-printed with high quality graphic images and/or text. For example, in FIG. 3 the planar sheet material (183) can be pre-printed.

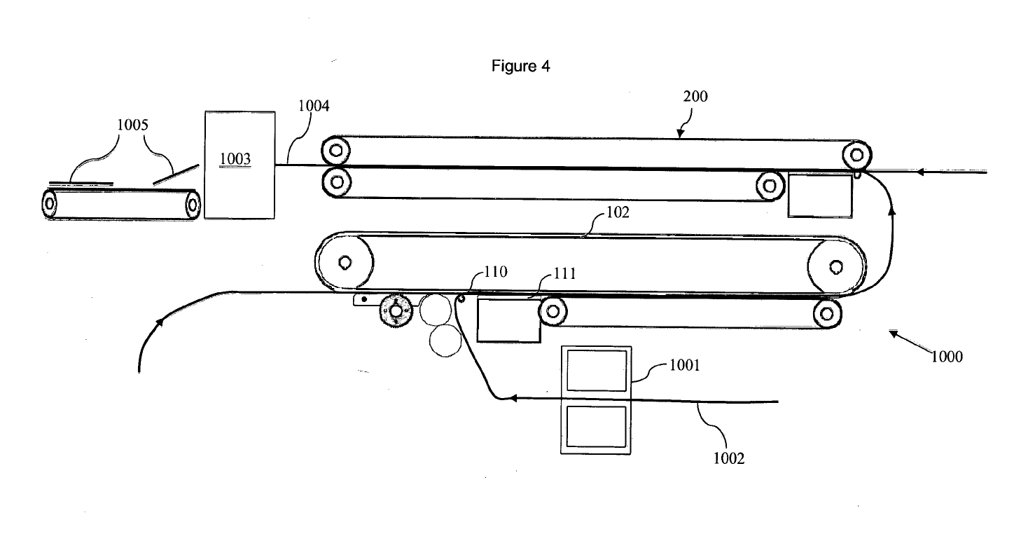

In FIG. 4 there is an apparatus (1000) for producing double face corrugated paperboard. The apparatus is similar to that shown in FIG. 3 but includes a number of further features:

First, the apparatus (1000) includes an industrial UV inkjet printer (1001) manufactured by XAAR (www.xaar.com) through which first liner sheet (1002) passes before going around redirect bar (110) and being fed between the endless fluted conveyor surface (102) and associated support surface (111).

Second, the apparatus (1000) includes a galvo-head CNC laser station (1003) which receives double face board (1004) exiting the double facer (200). The galvo-head CNC laser station (1003) cuts, scores or marks the double face board according to the product that is sought to be produced as pre-programmed. For example, the galvo-head CNC laser station can produce box blanks (1005) or other corrugated product blanks (not shown). The galvo-head CNC laser station includes an optical scanner which enables the laser to track the varying speed of the paperboard.

This embodiment has a number of features which provides additional advantages which can include:
the ability to print high quality graphic images as part of a continuous or line process for the manufacture of paperboard;
the ability to increase the speed at which printed paperboard is produced;
the ability to increase the speed of the paperboard manufacturing process when the industrial inkjet printer has a heat source which pre-heats the liner sheet which reduces the cure time for the adhesive; and
the ability to produce boxes which are pre-printed as part of a continuous process for the manufacture of paperboard.

### DETAILED DISCUSSION OF ALTERNATE WAYS TO IMPLEMENT THE INVENTION

The electromagnetic radiation source may include any source electromagnetic radiation capable of directly or indirectly heating paper and/or heating or curing adhesive suitable for bonding sheets of paper to one another.

In some embodiments there may be two or more different types of electromagnetic radiation. For example, there may be infrared radiation and UV radiation sources.

In some embodiments the additional types of radiation source may be utilised for purposes other than curing the adhesive.

In one embodiment the electromagnetic radiation source may be a medium wave IR heater.

In another embodiment the electromagnetic radiation source may be a medium wave carbon infrared heater.

In a further embodiment the electromagnetic radiation source may be a medium wave quartz infrared heater.

In a further embodiment the electromagnetic radiation source may be medium wave IR LEDs.

In another embodiment the electromagnetic radiation source may be a medium wave ceramic IR heater.

In still a further embodiment the electromagnetic radiation source may be a UV lamp.

The associated support surface may come in a variety of different forms without departing from the scope of the present invention.

In one embodiment the associated support surface may have a continuous uninterrupted support surface provided said surface emits electromagnetic radiation, or allows electromagnetic radiation, to pass therethrough.

In another embodiment the associated support surface may have a number of holes or slots therein which allow electromagnetic radiation to pass therethrough.

The holes and slots being arranged so the associated support surface is still capable of supporting the newly formed corrugated single face or double face paperboard.

In one embodiment the associated support surface may be CLEARCERAM™ glass-ceramic.

In another embodiment the associated support may be a quartz glass.

In some embodiments the glass may be a low thermal expansion glass.

The associated support surface may preferably be arranged to be capable of being raised or lowered with respect to the endless fluted conveyor. This ability to move the associated support surface towards and away from the endless fluted conveyor provides a number of advantages, two non-limiting examples are:
adjusting the degree of pressure placed on the planar and corrugated sheet materials during the lamination process; and
allowing the EMR surface to be automatically moved away from contact with the planar and corrugated sheet materials if the machine is stopped so as to lessen any risk of fire.

Aspects of the present invention have been described by way of example only and it should be appreciated that modifications and additions may be made thereto without departing from the scope thereof as defined in the appended claims.

1. A machine for producing corrugated paperboard, comprising:
an endless fluted conveyor belt assembly having an endless fluted conveyor belt including a plurality of adjacent flutes thereon wherein the flutes are configured to correspond to the teeth on a corrugating roller which is located at the upstream end of the endless fluted conveyor assembly;
at least one source of electromagnetic radiation and associated support surface comprising a substantially planar surface, from or through which, electromagnetic radiation is, or can be, emitted, whether directly or indirectly, said associated support surface being located downstream of a glue applicator, the associated support surface also positioned substantially parallel to, the plane of the endless fluted conveyor belt, and said associated support surface also being sufficiently proximate to the flutes on the endless fluted conveyor belt, so as in use, to be capable of at least partially holding newly glued planar sheet and corrugated sheet material together, against said flutes on the endless fluted conveyor.

2. A machine as claimed in claim 1 wherein the machine further includes an industrial inkjet printer which is positioned to print a planar liner sheet prior to the liner sheet being bonded to a corrugated sheet material.

3. A machine for producing corrugated paperboard as claimed in claim 1 wherein the associated support surface covers a source of electromagnetic radiation.

4. A machine for producing corrugated paperboard as claimed in claim 1 wherein the associated support surface is also the source of electromagnetic radiation itself.

5. A machine for producing corrugated paperboard as claimed in claim 1 wherein the source of electromagnetic radiation and associated support surface are located adjacently downstream of a redirect bar which brings the planar sheet into contact with droplets of glue on the crests of the corrugated sheet material.

6. A machine for producing corrugated paperboard as claimed in claim 1 wherein the associated support surface is located adjacently downstream of a redirect bar which brings the planar sheet into contact with droplets of glue on the crests of the corrugated sheet material.

7. A machine for producing corrugated paperboard as claimed in claim 1 wherein the machine includes an endless tensioned belt assembly which holds planar sheet material and the corrugated sheet material together so a bond is formed there between which is located adjacently downstream of the source of electromagnetic radiation and associated support surface.

8. A machine for producing corrugated paperboard as claimed in claim 1 wherein the machine includes a laminator module comprising:
upper and lower opposed contact surfaces at least one being in the form of a tensioned conveyor belt, the upper and lower opposed contact surfaces, in use, being configured to receive and press there between:
a) planar sheet material; and
b) single face corrugated sheet material from a corrugator module; and
a glue applicator for applying adhesive to the single face corrugated board and/or planar sheet material prior to travelling between the upper and lower contact surfaces which hold the planar sheet material and single face corrugated board together so a bond is formed there between; and
wherein either the upper or the lower opposed contact surface includes as part thereof, or is formed from, at least one source of electromagnetic radiation and associated support surface said associated support surface being positioned so as to at least partially hold newly glued double face sheet material together; and
wherein the machine further includes an industrial inkjet printer which is positioned to print a planar liner sheet prior to the liner sheet being bonded to a corrugated sheet material.

9. A corrugated sheet material produced by the machine as claimed in claim 1.

10. A machine for producing corrugated paperboard as claimed in claim 1 wherein the machine includes an industrial inkjet printer which is positioned to print a planar liner sheet prior to the liner sheet being bonded to a corrugated sheet material

11. A machine for producing corrugated paperboard as claimed in claim 1 wherein the machine includes a galvo-head laser unit positioned to cut paperboard exiting the machine.
